(19) United States
(12) Patent Application Publication
(10) Pub. No.: US 2005/0082834 A1
(43) Pub. Date: Apr. 21, 2005

(54) Self-powered electrical generator

(76) Inventor: Jonathan Gilbert Foster, Detroit, MI (US)

Correspondence Address: Jonathan G. Foster, 11715 Chelsea, Detroit, MI, 48213, US

(21) Appl. No.: 10/688,477

(22) Filed: Oct. 20, 2003

(51) Int. Cl. H02P 9/04; B60L 1/02; F02C 6/00

(52) U.S. Cl. 290/1 R

(57) ABSTRACT

The self-powered electrical generator is composed of components that are of current technology that I have arranged so that this new type of electrical generator does not require a secondary substance, power source, or the forces of nature to function. In addition, the unit is self-sustaining for indefinate periods of time. I have duplexed the components into full functioning sets to prolong the life of the components and to allow for the possibility of maintenance without interruption of service.

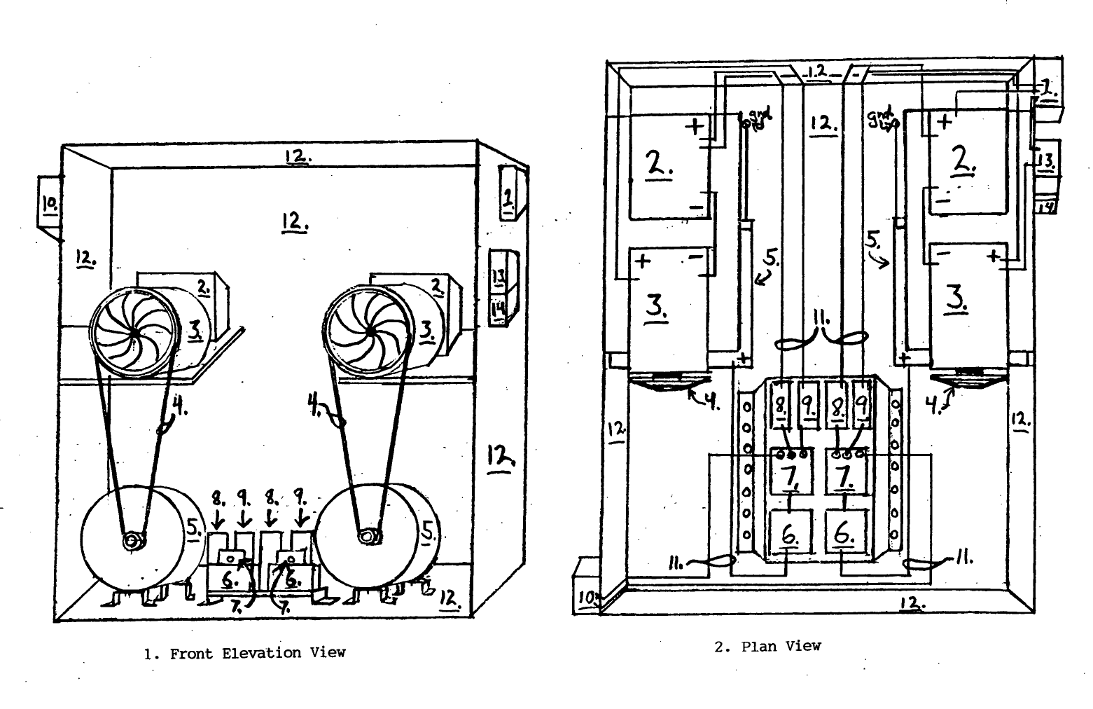

This is an improvement on the fuel-powered electrical generator, and generators powered by secondary substances and/or forces of nature.

The self-powered electrical generator shall use componets of pre-existing technology arranged in such a manner, and particular order, that it shall continuously operate without being dependant on a secondary power source.

In the drawing the componets listed below can be seen with a relative perspective to each other, the order in which they shall be arrayed, and how they shall function together within the housing.

Componet Items:

1.) The on/off switch, with circuit breaker.
2.) A 12-volt rechargable power-cell.
3.) A heavy-duty 12-volt electric motor, with attached gear-belt pulley.
4.) Gear-belt.
5.) 1000-1500 watt generator, with gear-belt pulley attached.
6.) Power converter, to increase voltage. (to 440 volts)
7.) Three-outlet junction box.
8.) Voltage Regulator “A”.
9.) Voltage Regulator “B”.
10.) Final Output connection/Junction box.
11.) Wiring.
12.) Insulated Steel Housing.
13.) Actuating Switch. (automatically timed)
14.) Manual “System select” switch.

### DETAILED DESCRIPTION OF THE SELF-POWERED ELECTRICAL GENERATOR

The Self-Powered Electrical Generator should be constructed of insulated, corrosion resistant, steel panel cube housing. It shall be as near to 36 inches in height, 48 inches in length, and 30 inches in width, as possible. It shall have an access panel for maintenance. There shall be a visible, ready-accessable, circuit-breaking, On/Off switch box. There shall be a visible, ready-accessable, manual, system-select switch that shall manually operate the actuating switch. Turning on the on/off switch will allow the 12-volt electrical power-cell to activate the 12-volt electrical, centrifical-rotating motor. A gear-belt pulley attached to the end of the center-shaft of the horizontally mounted electrical motor, shall spin vertically. It shall cause a gear-belt to spin vertically within the grooves of the pulley and make working contact with a second vertical pulley. The second vertical gear-belt pulley shall be attached to the end of the center-shaft of a horizontally mounted, centrifical, electrical generator. The generator shall be rated at 1000-1500 watts per hour of elecrtical output. The electrical output shall be produced as the generator is caused to spin due to the working contact between the gear-belt and the two pulleys. A power converter in-line, after the generator shall boost the electrical output to 440-volts. A three-outlet junction box shall be in-line after the power converter. A voltage-regulator in-line between outlet one of the three-outlet junction box and the electric motor, shall provide consistant voltage to the electric motor and take over for the power-cell. A second voltage-regulator between outlet two of the three-outlet junction box and the power-cell shall provide a consistant voltage to recharge the power-cell. A Final Output Connection/Junction Box shall be in-line, after output three, of the three-output junction box. The final output connection/junction box shall be visible and ready-accessable from the outside of the unit. The final output connection shall provide adequate voltage from the Self-Powered Elecrtical Generator unit to a circuit-breaker panel in a residential of commercial structure. The circuit-breaker panel shall provide the necessary electrical voltage to power lighting and electrical outlets for appliances in the structure. The set of componets shall be duplexed. The sets shall be separated by a timed actuating switch. This shall prolong the life of the componets.

1. The self-powered electrical generator differs from other generators because of its unique ability to operate constantly on a power supply that it produces itself. This is possible because I have arranged its components in such a particular order that the electrical output produced by the generator is first converted into a higher output, then it is regulated and used to power the electrical motor that spins the generator, and recharge the electrical power cell, and supply enough electrical output to power lighting, and appliances in a residential or commercial structure. To my knowledge, there is no other eletrical generator of this type in production or use.
